(19) United States
(12) Patent Application Publication
(10) Pub. No.: US 2009/0223124 A1
(43) Pub. Date: Sep. 10, 2009

(54) Long Range Self Watering System

(76) Inventors: Antonio A. Pasquariello, Los Angeles, CA (US); Bonita Louise Griffin Kaake, Lakewood, CO (US)

Correspondence Address: JACKSON ESQUIRE;ROGER A. JACKSON, 209 KALAMATH STREET, UNIT 9, DENVER, CO, 80223-1348, US

(21) Appl. No.: 12/400,802

(22) Filed: Mar. 10, 2009

Related U.S. Application Data
(60) Provisional application No. 61/068,787, filed on Mar. 10, 2008.

(51) Int. Cl. A01G 25/16; A01G 9/02

(52) U.S. Cl. 47/66.1; 47/81

(57) ABSTRACT

A watering system for controllably dampening the growth medium supporting a potted plant. The system includes a housing arranged to surround the lower portion of the pot as it is suspended from the top of the housing by a holder plate. The holder plate includes major and minor apertures for receiving the pot and a water meter that measures the level of water within a reservoir (catch basin) defined at the bottom of the housing. Moisture is controllably transported from the reservoir into the growth medium by means of a wick whose opposed ends are submerged in the reservoir and inserted into the growth medium by means of an elongated insertion tool.

### RELATED APPLICATION

This application claims priority from U.S. provisional patent application Ser. No. 61/068,787 filed Mar. 10, 2008 by Antonio A. Pasquariello.

### FIELD OF THE INVENTION

The present invention relates to systems for supporting the health and growth of potted plants. More particularly, the invention pertains to a system for controllably dampening the growth medium of a potted plant.

### DESCRIPTION OF THE PRIOR ART

It is recognized that the optimum environment for the health and growth of plants and vegetables includes oxygen from the atmosphere as well as complete (one hundred percent) humidity. Such a degree of humidity refers to maximum absorption of liquid by the surrounding growth medium. Common growth media for potted plants includes peat moss, clay, and such pumice like compositions as those marketed under the trademarks VERMICULITE® and PEARLITE®.

Pots for holding plants commonly include bottom apertures for drainage. The pots are generally paired with underlying flat plate-like elements for preventing spillage of water onto floors, tables, and other surfaces requiring protection.

Such plate-like elements necessarily include a recessed depth for holding water that has drained from the overlying pot. As most house plants are commonly tended by those who are either only casually aware or completely unaware of the conditions for optimum plant health, overwatering is a common occurrence. Such overwatering occurs when the plant and its surrounding growth medium are exposed to excessive watering beyond that required to achieve the condition of one hundred percent humidity. In such case, excess water fills and/or flows through the small voids that exist between individual elements of the growth medium. In either case, the circulation of air, including necessary oxygen, is inhibited, and in some cases eliminated. Such a condition (absence of oxygen combined with the organic matter of the growth medium) will lead to rotting of the plant, especially the roots. Even in the event that the apertures at the bottom of the pot permit some outflow of excess water, such outflow will only persist until such time as the level of excess water in the plate-like catch basin surrounding the bottom of the pot equals that within the bottom portion of the pot. This effectively “seals” the growth medium from air circulation, severely limiting access to oxygen.

### SUMMARY OF THE INVENTION

The present invention addresses the foregoing and other shortcomings of the prior art by providing an apparatus for controllably dampening a growth medium for supporting a plant. Such growth medium is contained within a pot comprising an encircling pot wall and a pot bottom having at least one aperture.

The apparatus includes a substantially-hollow housing comprising an encircling wall and a closed bottom. The wall of the housing is arranged to surround the lower portion of the pot.

An elongated wick member has opposed ends for embedding within the growth medium and the reservoir for transporting water from the reservoir into the medium.

The preceding and other features of the invention will become further apparent from the detailed description that follows. Such description is accompanied by a set of drawing figures. Numerals of the drawing figures, corresponding to those of the written specification, point to the features of the invention. Like numerals refer to like features throughout both the written description and the drawing figures.

### BRIEF DESCRIPTION OF THE DRAWINGS

FIG. 1 is an exploded perspective view of the housing of a watering system in accordance with an embodiment of the invention;

FIGS. 2(a) through 2(d) are a series of Figures for illustrating a wick, an inserter, and their cooperative use in accordance with an embodiment of the invention;

FIG. 3 is a side sectional assembled in use view of a watering system in accordance with the invention;

FIG. 4 is a perspective view of a flanged insert assembly with a plurality of flexible tines that are inwardly angled;

FIG. 5 is a side sectional assembled view of a watering system in accordance with the alternative embodiment of the invention including the flanged insert with the plurality of flexible tines that are inwardly angled;

FIG. 6 is an exploded perspective view of the housing of the watering system in accordance with an alternative embodiment of the invention including the flanged insert with the plurality of flexible tines that are inwardly angled; and

FIG. 7 is a side sectional assembled in use view of the alternative embodiment of the watering system in accordance with the invention including the flanged insert with the plurality of flexible tines that are inwardly angled.

### REFERENCE NUMBERS IN THE FIGURES

10 Housing
12 Potted plant
14 Growth medium
16 Plant
18 Pot
19 Aperture
20 Shell
22 Holder plate
23 Encircling wall that is a downwardly tapering wall
24 Closed bottom
26 Band of reduced diameter
28 First aperture
30 Downwardly tapered inner wall
32 Second aperture
34 Water meter
36 Elongated floatation element
38 Transparent region
40 Gradations
42 Aperture
44 Wick
46 Inserter
48 Hook
50 Water
54 Alternate embodiment of the watering system
55 Flanged insert assembly
60 Plurality of flexible tines
61 Longitudinal axis of each tine 60
65 Outer periphery of the flanged insert assembly 55
70 Inner periphery of the flanged insert assembly 55
75 Angle of the longitudinal axis 61

### DETAILED DESCRIPTION

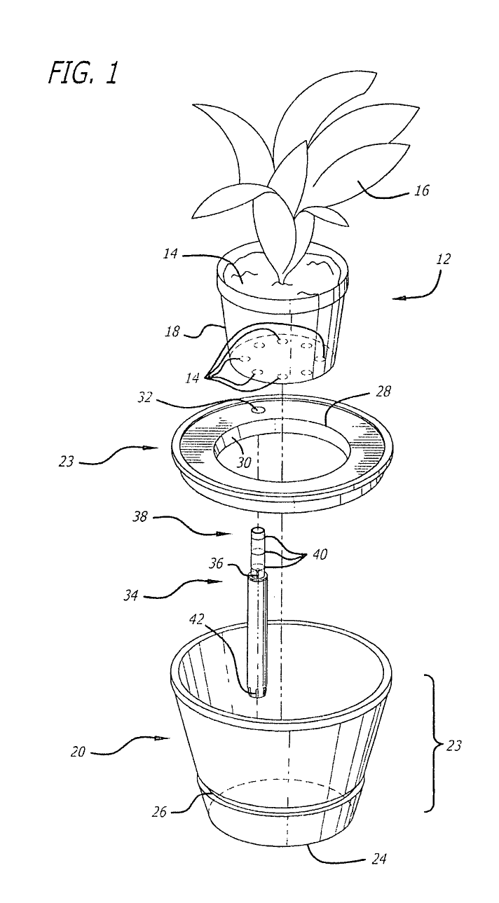

Turning now to the drawings, FIG. 1 is a perspective view of the housing 10 of the watering system in accordance with an embodiment of the invention. The housing 10 is provided for supporting a potted plant 12 in suspension above a reservoir formed at the closed bottom 24 of the housing 10. It will be shown below that the water 50 is transported by the watering system into a growth medium 14 that supports a plant 16 within a pot 18.

The pot 18 is typically of plastic, clay, or other ceramic material, either glazed or unglazed. At least one aperture 19 is commonly provided for drainage at the bottom of the pot 18. As mentioned above, the pot 18 is normally seated on a plate-like element that permits the accumulation of water in a catch basin surrounding the bottom of the pot 18. Such a basin inhibits the circulation of air and oxygen required for plant health. In contrast, it will be seen that the invention provides a means for suspending the pot 18 to prevent the accumulation of water blockage to the circulation of air while assuring one hundred percent humidity of the growth medium for optimum plant health.

The housing 10 comprises a shell 20 and holder plate 22. The shell 20, preferably integrally formed of molded plastic, has an open top, an encircling, downwardly-tapered wall 23 and a closed bottom 24. A band 26 of reduced diameter within the wall 23 is provided for facilitating the transport of multiple shells 20. That is, the reduced diameter of the band 26 allows the telescoping of multiple shells for compact transport without the locking that would otherwise occur if adjacent shells were permitted to bottom out against one another in a “nesting” type of situation.

The holder plate 22 includes a first aperture 28 for receiving the pot 18. As the pot 18 is typically downwardly-tapered, the inner wall 30 of the aperture 28 is correspondingly tapered. This permits the use of the housing 10 with a variety of pot sizes, provided that the bottom of the pot 18 is suspended above the closed bottom 24 of the housing.

A second aperture 32 in the holder plate 22 is provided for receiving a water meter 34 of the flotation type. Such meter 34 comprises an elongated flotation element 36 within a meter housing that includes a transparent region 38 having gradations 40 for measuring the position of the top of the elongated flotation element 36. At least one aperture 42 is provided adjacent the bottom of the meter housing. The aperture(s) 42 admit water from the reservoir formed during use at the bottom of the housing 10, causing the position of the elongated flotation element 36 to adjust in a vertical direction within the meter housing 38. The position of the flotation element is visually measurable by means of the markings 40 on the transparent portion 38 of the meter housing.

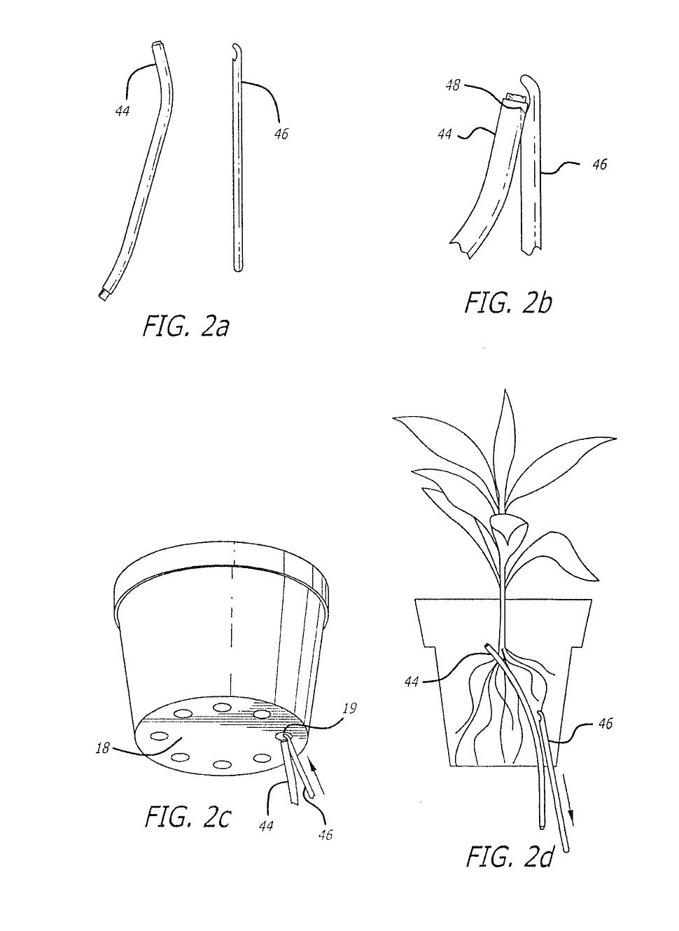

FIGS. 2(a) through 2(d) are a series of figures for illustrating a wick 44, an inserter 46 and their cooperative use in accordance with an embodiment of the invention. As explained above, optimum plant health is characterized by the maintenance of one hundred percent humidity of the growth medium 14 in which the plant 16 is established. This is not to be confused with the drenching or overwatering that is characterized by the presence of excessive water that fills the voids that exist between particles of the growth medium 14. The filling of such voids, which occurs most commonly was a consequence of the presence of “free” water at the bottom of the pot 18 in equilibrium with the level of water in the catch basin formed by the flat plate-like element in which the pot 18 is seated, prevents the circulation of air that is necessary for plant health.

Turning to FIG. 2(a) the wick 44 comprises a wettable cotton element surrounded by a fabric jacket, preferably of NYLON. The opposed ends of the jacket of the wick 44 are melted to prevent shredding. The inserter 46 is a rigid, elongated tool having a hook 48 at one end for grasping an end of the wick 44 and inserting the combined wick 44-and-inserter 46 through an aperture 19 at the bottom of the pot 18 and into the growth medium 14 therein as illustrated in FIG. 2(c). In FIG. 2(d), the inserter has unhooked from the wick 44 after insertion into the growth medium 14 and been withdrawn, leaving one end of the wick 44 extending into the growth medium 14 and extending through the aperture 19 and out of the bottom of the pot 18.

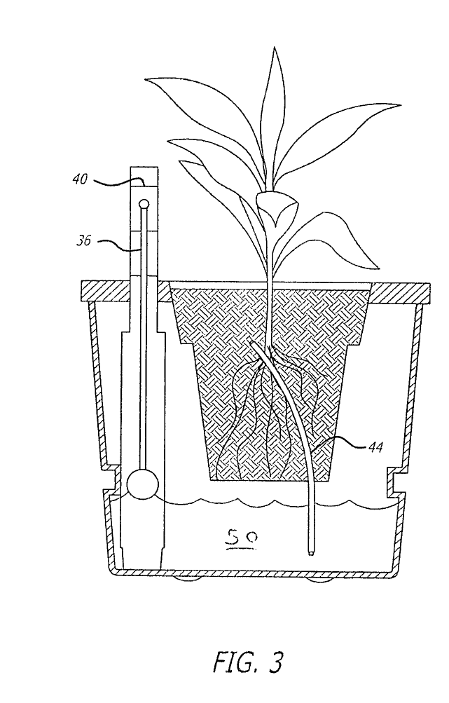

The wick 44 provides a means for controllably transferring water from the reservoir at the bottom of the housing 10 to thereby moisten the growth medium 14 that surrounds the plant 16 within the pot 18. FIG. 3 is a side sectional assembled view of a watering system in accordance with the invention. The system is employed by first introducing a quantity of water 50 into the bottom of the shell 20, creating a reservoir. The wick 44 is inserted into the growth medium 14 within the pot 18 as illustrated in FIGS. 2(c) and 2(d) above.

The water meter 34 is inserted into the aperture 32 and thereby fixed to the holder plate 22 in such a way as to extend substantially the entire distance between the holder plate 22 and the closed bottom 24 of the shell 20. This enables the entry of water from the reservoir at the bottom of the shell 20 to enter the bottom of the meter housing to thereby actuate the elongated flotation element 36 to responsively indicate the depth of water in the reservoir visibly at the transparent portion 38 of the meter housing.

Water 50 is transported by capillary action from the underlying reservoir and into the growth medium 14 through the wick 44. Such flow of water 50 continues until the capillary flow is terminated by the equalization of capillary forces due to vapor pressures at the opposed ends of the wick 44. This occurs when a one hundred percent humidity condition is reached within the growth medium 14. Such condition assures correct moisture content while retaining the void spaces between particles of the growth medium 14 to permit the circulation of oxygen.

The water meter 34 provides a visible indication of the depth of the reservoir that exists beneath, and separate from, the potted plant 12. This allows one to replenish the reservoir regularly and at the proper time to assure that the condition of one hundred percent humidity is maintained in the growth medium and avoids the common overwatering phenomenon that is often undertaken “to be safe”.

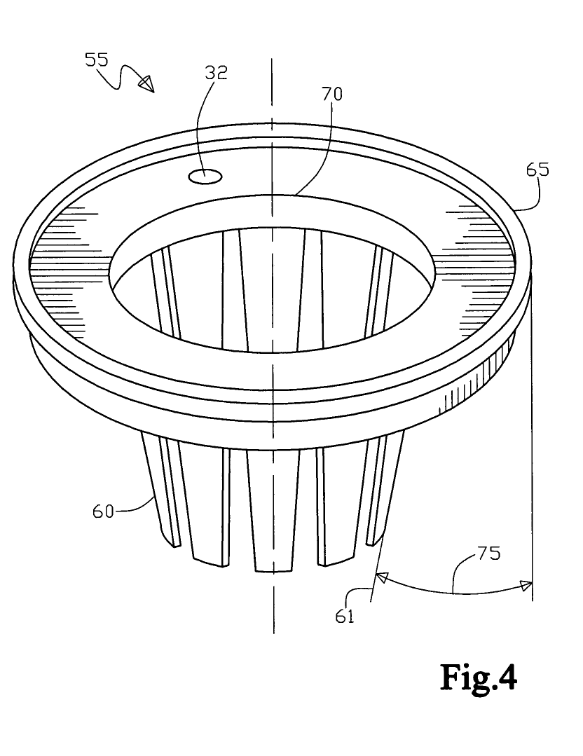

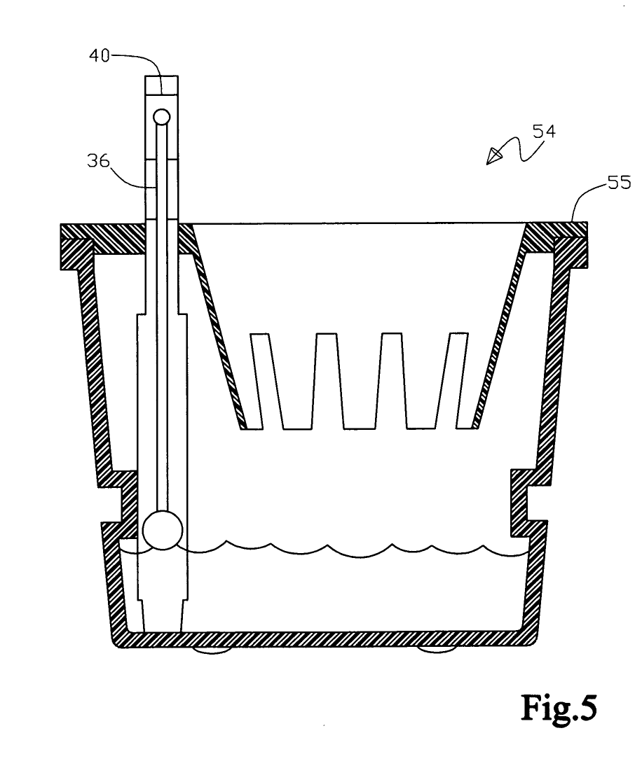

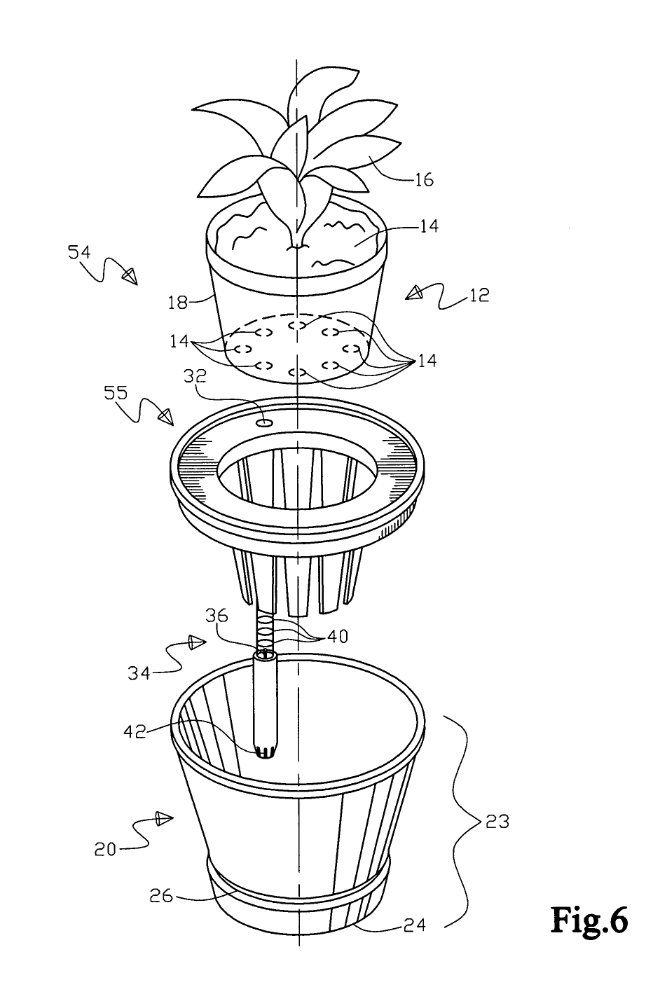

In looking at the alternative embodiments for the watering system apparatus as best shown in FIGS. 4 through 7, for controllably dampening a growth medium 14 for supporting a plant 16, the medium 14 being contained within the pot 18 comprising an encircling pot wall and a pot bottom having at least one aperture 19. The alternative embodiments of the watering system apparatus including, in combination: a substantially-hollow housing including a shell 20 comprising an encircling wall 23 and a closed bottom 24 and defining a reservoir region at the bottom of the shell 20. Further included in the alternative embodiments for the watering system apparatus 54 are a flanged insert assembly 55 adjacent to the encircling wall 23, the flanged insert assembly 55 having an outer periphery 65 and an inner periphery 70. The flanged insert assembly 55 also having a plurality of flexible tines 60 extending therefrom adjacent to the inner periphery 70 for suspending the pot 18 with respect to the closed bottom 24 of the shell 20.

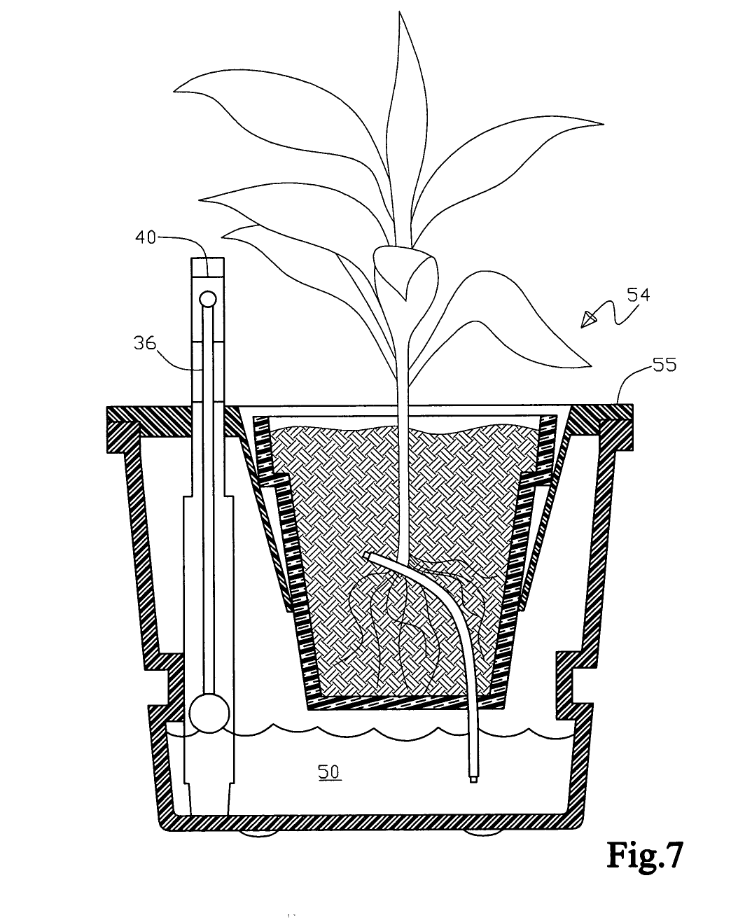

Further included in the alternative embodiment for the watering system apparatus 54 is the elongated wick 44 member having opposed ends for transporting water 50 from the reservoir region into the medium 14 as best shown in FIG. 7. Optionally, for the alternative embodiment for the watering system apparatus 54 the plurality of flexible tines 60 each have a longitudinal axis 61 that is angled 75 toward one another, such that the plurality of flexible tines 60 form a frustroconical shape that is operational to suspend a multitude of different pot sizes, see FIGS. 4 through 7.

Further, in looking at the other alternative embodiments for the watering system apparatus 54 as best shown in FIGS. 4 through 7, for controllably dampening a growth medium 14 for supporting a plant 16, the medium 14 being contained within the pot 18 comprising an encircling pot wall and a pot bottom having at least one aperture 19. The alternative embodiments of the watering system apparatus 54 include, in combination: a substantially-hollow housing including a shell 20 comprising an encircling wall 23 and a closed bottom 24 and defining a reservoir region at the bottom of the shell 20. Further included in the alternative embodiments for the watering system apparatus 54 are a flanged insert assembly 55 adjacent to the encircling wall 23, the flanged insert assembly 55 having an outer periphery 65 and an inner periphery 70. The flanged insert assembly 55 also having a surrounding sidewall extending therefrom adjacent to the inner periphery 70 for suspending the pot 18 with respect to the closed bottom 24 of the shell 20. Wherein the surrounding sidewall follows essentially the same cross-sectional profile of the previously discussed tines 60, however, being a continuous sidewall as best shown in FIG. 7, as opposed to the tines 60 having gaps between them.

Further included in the other alternative embodiment for the watering system apparatus 54 is the elongated wick 44 member having opposed ends for transporting water 50 from the reservoir region into the medium 14 as best shown in FIG. 7. Optionally, for the other alternative embodiment of the watering system apparatus 54 the surrounding sidewall can form a frustroconical shape that reduces in periphery as the surrounding sidewall extends adjacent from the inner periphery 70 that is operational to suspend a multitude of different pot 18 sizes, again as best shown in FIG. 7.

The preferred materials of construction for the housing 10 including the alternative embodiment 54 would be typical for the plant container industry normally being a waterproof plastic or other suitable alternatives. However, specifically relating to the plurality of flexible tines 60 and the surrounding sidewall, the preferred materials of construction would be a flexible waterproof plastic or other suitable alternatives.

While this invention has been described with reference to a presently preferred embodiment, it is not limited thereto. Rather, the invention is limited only insofar as it is defined by the following set of patent claims and includes within its scope all equivalents thereof.

1. A watering system apparatus for controllably dampening a growth medium for supporting a plant, said medium being contained within a pot comprising an encircling pot wall and a pot bottom having at least one aperture, said apparatus comprising, in combination:
(a) a substantially-hollow housing including a shell comprising an encircling wall and a closed bottom and defining a reservoir region at the bottom of said shell;
(b) said housing including means for suspending said pot with respect to said closed bottom of said shell; and
(c) an elongated wick member having opposed ends for transporting water from said reservoir region into said medium.

2. A watering system apparatus as defined in claim 1 wherein said housing further includes:
(a) a holder plate;
(b) said holder plate being located adjacent a top edge of said wall of said shell; and
(c) said holder plate having an aperture for receiving a pot.

3. A watering system apparatus as defined in claim 2 wherein said aperture is inwardly-tapered for receiving a tapered pot.

4. A watering system apparatus as defined in claim 3 wherein said holder plate includes a second aperture for receiving an elongated water meter.

5. A watering system apparatus as defined in claim 4 wherein;
(a) said holder plate has a circular periphery; and
(b) each of said apertures is de-decentered with respect to said holder plate.

6. A watering system apparatus as defined in claim 1 wherein said shell further includes:
(a) said wall of said shell being generally downwardly-tapered; and
(b) said wall including a band of reduced diameter.

7. A watering system apparatus as defined in claim 1 further including an elongated water meter for measuring the depth of liquid within said reservoir.

8. A watering system apparatus as defined in claim 7 wherein said water meter includes an elongated flotation member.

9. A watering system apparatus as defined in claim 8 wherein said elongated flotation member is received within a meter housing having at least one aperture adjacent the bottom thereof.

10. A watering system apparatus as defined in claim 9 wherein said meter housing of said water meter further includes a transparent region having graduated markings for indicating the depth of water within said reservoir.

11. A watering system apparatus for controllably dampening a growth medium for supporting a plant, said medium being contained within a pot comprising an encircling pot wall and a pot bottom having at least one aperture, said apparatus comprising, in combination:
(a) a substantially-hollow housing including a shell comprising an encircling wall and a closed bottom and defining a reservoir region at the bottom of said shell;
(b) said housing including a flanged insert assembly adjacent to said encircling wall, said flanged insert assembly having an outer periphery and an inner periphery, said flanged insert assembly also having a plurality of flexible tines extending therefrom adjacent to said inner periphery for suspending said pot with respect to said closed bottom of said shell; and
(c) an elongated wick member having opposed ends for transporting water from said reservoir region into said medium.

12. A watering system apparatus as defined in claim 11 wherein said plurality of flexible tines each have a longitudinal axis that is angled toward one another, such that said plurality of flexible tines form a frustroconical shape that is operational to suspend a multitude of different pot sizes.

13. A watering system apparatus for controllably dampening a growth medium for supporting a plant, said medium being contained within a pot comprising an encircling pot wall and a pot bottom having at least one aperture, said apparatus comprising, in combination:
(a) a substantially-hollow housing including a shell comprising an encircling wall and a closed bottom and defining a reservoir region at the bottom of said shell;
(b) said housing including a flanged insert assembly adjacent to said encircling wall, said flanged insert assembly having an outer periphery and an inner periphery, said flanged insert assembly also having a surrounding sidewall extending therefrom adjacent to said inner periphery for suspending said pot with respect to said closed bottom of said shell; and
(c) an elongated wick member having opposed ends for transporting water from said reservoir region into said medium.

14. A watering system apparatus as defined in claim 13 wherein said surrounding sidewall forms a frustroconical shape that reduces in periphery as said surrounding sidewall extends adjacent from said inner periphery that is operational to suspend a multitude of different pot sizes.
